(19) United States
(12) Patent Application Publication
(10) Pub. No.: US 2005/0165856 A1
(43) Pub. Date: Jul. 28, 2005

(54) System and method for autonomic performance enhancement of storage media

(75) Inventors: Craig William Fellenstein, Brookfield, CT (US); Carl Phillip Gusler, Austin, TX (US); Rick Allen Hamilton, Charlottesville, VA (US); James Wesley Seaman, Falls Church, VA (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/765,777

(22) Filed: Jan. 27, 2004

(51) Int. Cl. G06F 12/00

(52) U.S. Cl. 707/200

(57) ABSTRACT

A method, an apparatus, and a computer program are provided for improving the performance of a disk drive. Due to the problem of file fragmentation that occurs with multiple, writes, deletes, and rewrites, the performance of a storage drive can be drastically affected. Typically, the performance is as a result of increased access times to files. To alleviate the problem, a method, an apparatus, and a computer program are provided to track file fragmentations and actively defragment storage drives when the computer system using the drive is idle. Thus, the drive performance is maintained without lengthy engagement of defragmentation programs initiated by user.

### BACKGROUND OF THE INVENTION

1. Field of the Invention

The present invention relates generally to the improvement of operation of storage media and, more particularly, to improving the storage algorithms on storage media.

2. Description of the Related Art

Within a computer system, there are a variety of types of storage media that range from volatile and nonvolatile memory, typical types of magnetic media, to new magneto-optic media. Specifically, there are a series of nonvolatile magnetic and magneto-optic storage media that utilize a head and rotating disks or platters, such as a Hard Disk Drive (HDD) or a Floppy Disk Drive. Files are placed on the rotating disk at easily accessible locations depending on the configuration of the disk system. If it is a multi-platter, multi-head assembly, then the configuration can vary from drive to drive.

The majority of disk systems used today are designed to provide maximum write performance. In other words, the drives are designed to write to the disk or disks at a maximum rate. In multi-platter systems, maximum write speed usually results in the utilization of all available heads writing across different platters. Hence, storage blocks for files are not contiguous, but are scattered. As files are deleted or updated, storage blocks become even more widely scattered in a non-contiguous fashion, or fragmented.

This fragmentation may start from a desire for maximum write speed, but efficiency in accessing the files is decreased. The heads are required to seek across large portions of the entire disk system to locate clusters or sectors containing file fragments. The fragmentation may appear to be insignificant; however, over time with a number of files written, deleted, or rewritten, files fragments can be scattered to a point where access time to files is so long as to create drastic delays.

To alleviate the problem associated with file fragmentation, a common practice is to defragment the drive periodically. Defragmentation is typically initiated by a user or administrator and can require several minutes to several hours to complete. Also, defragmentation usually occurs once the fragmentation has or is causing critical delays. These critical delays typically result in a loss of productivity.

Therefore, there is a need for a method and/or apparatus for improving the read and write capabilities for a disk drive that addresses at least some of the problems associated with fragmentation while utilizing conventional methods and apparatuses for the read and write capabilities of a disk drive.

### SUMMARY OF THE INVENTION

The present invention provides a method for monitoring file defragmentation of at least one storage medium at least coupled to a computer system. A determination is made as to if file fragmentation occurs when data is written to, deleted from, or scanned from the at least one storage media. Also, locations of a plurality of file fragments are stored when the system monitor has at least determined that file fragmentation has occurred in a storage medium.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a platter containing fragmented files;

FIG. 2 is a block diagram depicting a defragmented platter;

FIG. 3 is a flow chart depicting the operation of a fragmentation tracker and defragmentation agent; and

FIG. 4 is a block diagram depicting file attribute measurements for use in the defragmenter.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or integrated circuits that are coded to perform such functions, unless indicated otherwise.

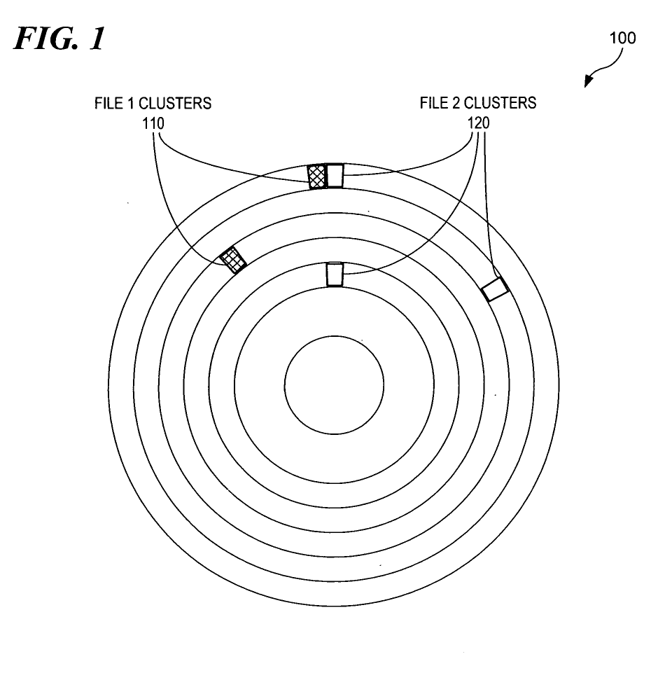

Referring to FIG. 1 of the drawings, the reference numeral 100 generally designates a platter containing fragmented files. Within the platter 100, there typically can be several thousand to several billion or more clusters (not shown). These clusters typically store a small amount of data magnetically. Hence, a file typically cannot be stored in a single cluster, but in multiple clusters. For example, File 1 Clusters 110 and File 2 Clusters 120 are spread across the platter. The unordered pattern of the File 1 Clusters 110 and the File 2 Clusters 120 denotes file fragmentation.

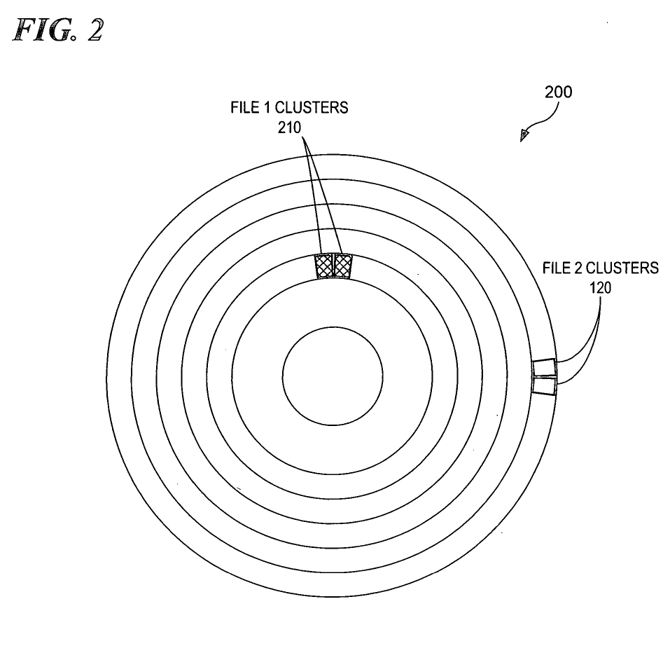

Referring to FIG. 2 of the drawings, the reference numeral 200 generally designates a defragmented platter. Also, within the platter 200, there typically can be several thousand to several billion or more clusters (not shown) However, in a defragmented platter, file clusters are ordered into a specific pattern. For example, File 1 Clusters 210 and File 2 Clusters 220 are not spread across the entire platter, but are precisely ordered.

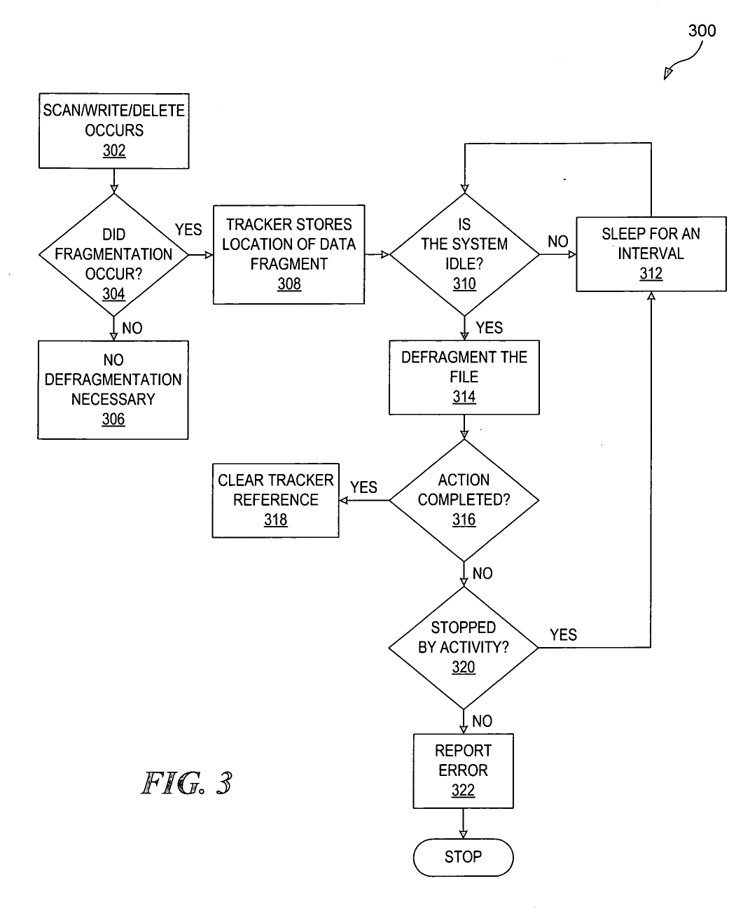

Referring to FIG. 3 of the drawings, the reference numeral 300 generally designates a flow chart depicting the operation of a fragmentation tracker and a defragmentation agent. In order to better improve efficiency of the disk drive, two distinct algorithmic creations, the fragmentation tracker and the defragmentation agent, are utilized. The fragmentation tracker is responsible for monitoring and maintaining an account of the location of fragmented file clusters. The defragmentation agent is responsible for implementing defragmentation of the file fragmentations determined by the fragmentation tracker. The procedure for the operation of the fragmentation tracker and the defragmentation agent are depicted with the flow chart 300.

Steps 302, 304, 306, and 308 depict the operation of the fragmentation tracker. In step 302, a scan, write, or delete occurs as a result of data storage operation. For example, a user deletes a file. In step 304, once the scan, write, or delete has occurred, the fragmentation tracker must determine if file fragmentation has occurred. In step 306, if file fragmentation has not occurred, then no defragmentation is necessary. In step 308, if file fragmentation has occurred, then the fragmentation tracker stores the location of the file fragments for future defragmentations.

If defragmentation is necessary, then in step 310, a determination of whether the system is idle must be made. Typically, in conventional systems, the user would initiate a defragmentation algorithm to alleviate the problems associated with fragmentation. However, it is inefficient to wait until fragmentation causes substantial or critical delays. There would be a better use of computer resources to operate defragmentation algorithms during inactive periods that occur intermittently. Hence, in step 312, if the system is not idle, then the defragmentation agent remains dormant until the system is idle.

Once the system becomes idle, then in step 314, the file is defragmented. The defragmentation then continues until the file is completely defragmented 316. Once the defragmentation is complete, then the tracker reference regarding the defragmented file is reset 318.

The agent, though, does not completely lock out usage once defragmentation begins. During the defragmentation completion process 316, defragmentation can be stopped. If defragmentation is stopped before completion, there should be a determination as to whether the defragmentation has been halted as a result of activity 320. If there has not been any activity, then an error is reported. If there has been activity, the agent becomes dormant and waits for the system to become idle again 312.

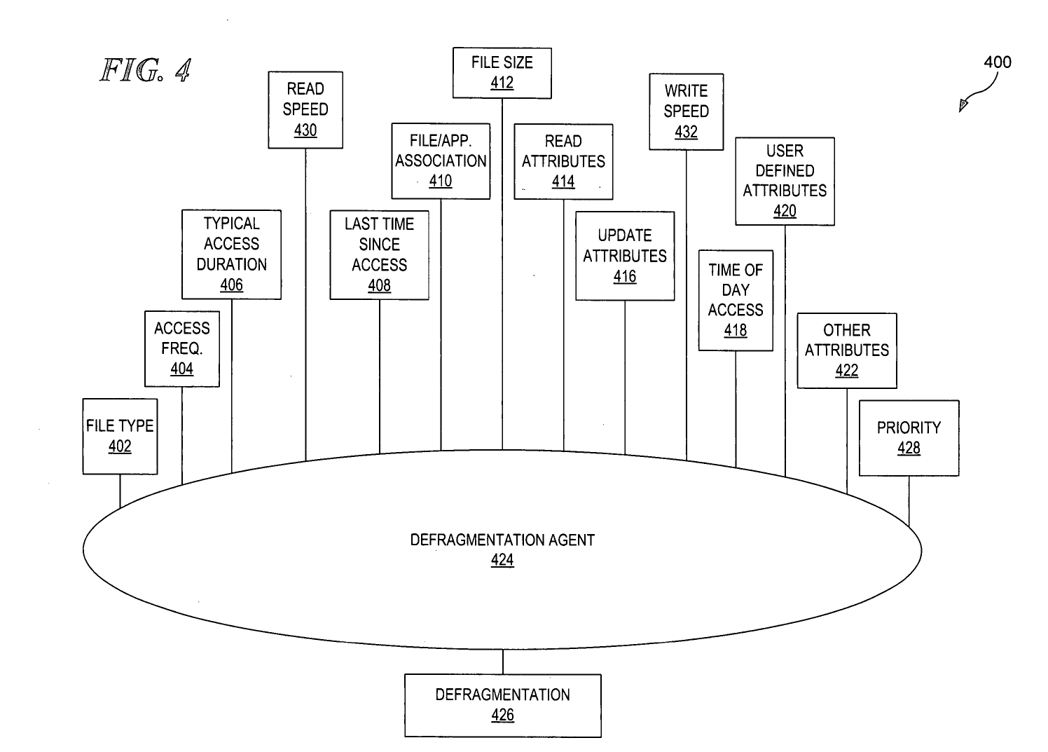

Referring to FIG. 4 of the drawings, the reference numeral 400 generally designates a block diagram depicting file attribute measurements for use in the defragmenter.

Depending on the disk drive type and usage, the characteristics for defragmentation of the drive vary based on the desired usage. In the typical desktop computer, when a drive is defragmented, the user has virtually no input on the defragmentation algorithm. For example, the user is typically unable to set defragmenter priorities for file types. However, systems administrators can have much more input into drive defragmentation. For example, a systems administrator can set priorities for file types. There can be a variety of user-defined attributes that define the defragmentation. The most likely user defined attributes would include such settings as read speed 430, write speed 432, access frequency 404, and so forth. Typically, there are several other attributes that can be used in a defragmentation, such as file size 412, typical duration of access time 406, file/application association 410, last time since accessed 408, read characteristics 414, update characteristics 416, time of day access normally occurs 418, application priority 428, and file/application type 402. There may also be a variety of other attributes that contributed to defining a defragmentation 422.

Once all of the attributes have been entered into the algorithm, the defragmentation agent 424 can properly function. The inputted attributes allow for a variety of desired performance enhancements. Taking into account all of the inputted attributes, the defragmentation agent then may re-associate file clusters to locations on the platter or platters that correspond to the specific, desired defragmentation 426.

It will further be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. An apparatus for file defragmentation of at least one storage medium, comprising:
a computer system at least coupled to the at least one storage medium;
a tracker, wherein the tracker is at least configured to maintain a record of at least locations of a plurality of file fragments on at least one storage medium; and
an agent, wherein the agent is at least:
configured to operate while the computer system is at least idle;
configured to defragment the plurality of file fragments; and
configured to delete the record of at least locations of the plurality of file fragments.

2. The apparatus of claim 1, wherein the agent further comprises at least having the ability to modify attributes of defragmentation.

3. The apparatus of claim 2, wherein the attributes are selected from the group consisting of file type, frequency of access, typical access duration, interval between accesses, file/application association, file size, read attributes, update attributes, and time of day of typical access.

4. An apparatus for monitoring file defragmentation of at least one storage medium at least coupled to a computer system, comprising:
a memory, wherein the memory is at least configured to store locations of a plurality of file fragments;
a system monitor, wherein the system monitor at least determines if file fragmentation occurs when data is written to, deleted from, or scanned from the at least one storage media; and
an accounting means, wherein the accounting means is at least configured to store locations of a plurality of file fragments when the system monitor has at least determined that file fragmentation has occurred.

5. An apparatus for file defragmentation of at least one storage medium at least coupled to a computer system, comprising:
a memory, wherein the memory is at least configured to store locations of a plurality of file fragments;
an idle monitor, wherein the idle monitor is at least configured to enable defragmentation while the computer system is at least idle;
a defragmenter, wherein the defragmenter is at least configured to defragment the plurality of file fragments; and
an update monitor, wherein the update monitor is at least configured to delete a record in the memory of at least locations of the plurality of file fragments that at least been defragmented.

6. The apparatus of claim 5, wherein the agent further comprises at least having the ability to modify attributes of defragmentation.

7. The apparatus of claim 6, wherein the attributes are selected from the group consisting of file type, frequency of access, typical access duration, interval between accesses, file/application association, file size, read attributes, update attributes, and time of day of typical access.

8. A method of for file defragmentation of at least one storage medium coupled to a computer system, comprising:
determining if fragmentation occurs when data is written to, deleted from, or scanned from the at least one storage media;
storing locations of a plurality of file fragments when the system monitor has at least determined that file fragmentation has occurred in a storage medium;
determining if the computer system is idle;
if the computer system is not idle, sleeping for an interval;
if the computer system is idle, defragmenting a file;
determining if defragmentation is complete;
if defragmentation is complete, deleting the location of the fragmented file clusters in the storage medium;
if defragmentation is not complete, determining if defragmentation is stopped by activity;
if defragmentation is stopped by activity, sleeping for an interval; and
if defragmentation is not stopped by activity, reporting an error.

9. A method for monitoring file defragmentation of at least one storage medium at least coupled to a computer system, comprising:
determining if file fragmentation occurs when data is written to, deleted from, or scanned from the at least one storage media; and
storing locations of a plurality of file fragments when the system monitor has at least determined that file fragmentation has occurred in a storage medium.

10. A method of defragmenting at least one storage medium coupled to a computer system, comprising:
determining if the computer system is idle;
if the computer system is not idle, sleeping for an interval;
if the computer system is idle, defragmenting the file;
determining if defragmentation is complete;
if defragmentation is complete, deleting a location of the fragmented file clusters in a storage medium;
if defragmentation is not complete, determining if stopped by activity;
if defragmentation is stopped by activity, sleeping for an interval; and
if defragmentation is not stopped by activity, reporting an error.

11. A computer program product for file defragmentation of at least one storage medium at least coupled to a computer system, the computer program product having a medium embodied thereon, the computer program comprising:
computer code for determining if fragmentation occurrs when data is written to, deleted from, or scanned from the at least one storage media;
computer code for storing locations of a plurality of file fragments when the system monitor has at least determined that file fragmentation has occurred in a storage medium;
computer code for determining if the computer system is idle;
if the computer system is not idle, computer code for sleeping for an interval;
if the computer system is idle, computer code for defragmenting a file;
computer code for determining if defragmentation is complete;
if defragmentation is complete, computer code for deleting the location of the fragmented file clusters in the storage medium;
if defragmentation is not complete, computer code for determining if defragmentation is stopped by activity;
if defragmentation is stopped by activity, computer code for sleeping for an interval; and
if defragmentation is not stopped by activity, computer code for reporting an error.

12. A computer program product for monitoring file defragmentation of at least one storage medium at least coupled to a computer system, the computer program product having a medium embodied thereon, the computer program comprising:
computer code for determining if file fragmentation occurs when data is written to, deleted from, or scanned from the at least one storage media; and
computer code for storing locations of a plurality of file fragments when the system monitor has at least determined that file fragmentation has occurred in a storage medium.

13. A computer program product for defragmenting at least one storage medium coupled to a computer system, the computer program product having a medium embodied thereon, the computer program comprising:
computer code for determining if the computer system is idle;
if the computer system is not idle, computer code for sleeping for an interval;
if the computer system is idle, computer code for defragmenting a file;
computer code for determining if defragmentation is complete;
if defragmentation is complete, computer code for deleting a location of the fragmented file clusters in a storage medium;
if defragmentation is not complete, computer code for determining if stopped by activity;
if defragmentation is stopped by activity, computer code for sleeping for an interval; and
if defragmentation is not stopped by activity, computer code for reporting an error.
